(19) United States
(12) Patent Application Publication
(10) Pub. No.: US 2015/0344127 A1
(43) Pub. Date: Dec. 3, 2015

(54) AEROELASTICALLY TAILORED PROPELLERS FOR NOISE REDUCTION AND IMPROVED EFFICIENCY IN A TURBOMACHINE

(71) Applicant: General Electric Company, Schenectady, NY (US)

(72) Inventors: Trevor Howard Wood, Clifton Park, NY (US); Kishore Ramakrishnan, Clifton Park, NY (US)

(73) Assignee: General Electric Company, Schenectady, NY (US)

(21) Appl. No.: 14/292,873

(22) Filed: May 31, 2014

(51) Int. Cl. B64C 11/50

(52) U.S. Cl. CPC B64C 11/50

(57) ABSTRACT

Aeroelastically tailored propellers for noise reduction and improved efficiency in a turbomachine are provided including one or more upstream blades and one or more downstream blades disposed downstream relative to the one or more upstream blades. Each of the one or more upstream blades and the one or more downstream blades are aeroelastically tailored such that the one or more downstream blades include a greater degree of effective clipping during a second condition than at a first condition. Each blade among the one or more upstream blades comprises one or more geometric parameters. Each blade among the one or more downstream blades comprises one or more geometric parameters. In addition, an open rotor aircraft gas turbine engine assembly including the aeroelastically tailored propellers and a method of decreasing noise and improving efficiency in a turbomachine are disclosed.

### BACKGROUND

The disclosure relates generally to turbomachines and, more particularly, to arrangement of blades in turbomachines so as to reduce noise during operation.

Gas turbine engine manufacturers are faced with the problem of developing new ways of effectively reducing noise. One of the common noise sources includes noise generated by the turbomachinery within the gas turbine engine. It has long been recognized that in turbomachines one of the principal noise sources is the interaction between the wakes of upstream blades and downstream blades during operation. This wake interaction results in noise at the upstream blade passing frequency and at its harmonics, as well as broadband noise covering a wide spectrum of frequencies.

In one type of turbomachinery, noise results from a relative motion of adjacent sets of blades, such as of those found in compressors (including fans) and turbines. For example, a compressor comprises multiple bladed stages, each stage including a rotatable blade row and possibly a stationary blade row. Another type of turbomachinery blade system of particular interest are propeller blades in an open rotor type propeller system, including counter-rotatable propellers. Vortices produced by a forward propeller travel rearward, into the aft propeller where it “chops” each vortex, producing noise. One reason why the chopping causes noise is that the tip vortex changes the momentum field through which the propeller travels. The change causes the forces on the propeller blade to momentarily change, and noise results.

One of the commonly used methods to reduce the wake interaction noise in turbomachinery is to increase the axial spacing between adjacent sets of blades. This modification provides space for the wake to dissipate before reaching the downstream set of blades, resulting in less noise. However, increased spacing of blades in turbomachines increases axial length of the machine leading to more weight, aerodynamic performance losses, and/or installation and space requirements.

Therefore, an improved means of reducing the wake interaction noise in turbomachinery is desirable.

### BRIEF DESCRIPTION

In accordance with one exemplary embodiment of the present disclosure, an apparatus is provided. The apparatus includes one or more upstream blades each comprising one or more geometric parameters and one or more downstream blades disposed downstream relative to the one or more upstream blades and each comprising one or more geometric parameters. The geometric parameters of each of the one or more upstream blades and the one or more downstream blades provide aeroelastic tailoring such that the one or more downstream blades includes a greater degree of effective clipping during a second condition than at a first condition.

In accordance with another exemplary embodiment of the present disclosure, An open rotor aircraft gas turbine engine assembly is provided. The open rotor aircraft gas turbine engine assembly includes an outer casing, a gas generator housed within the outer casing, a forward annular row of a first set of blades disposed radially outwardly of the outer casing and an aft annular row of a second set of blades disposed radially outwardly of the outer casing. The gas generator including a compressor section, a combustor section and a turbine section, wherein the compressor section, the combustor section and the turbine section are configured in a downstream axial flow relationship. Each blade of the first set of blades including one or more geometric parameters. Each blade of the second set of blades including one or more geometric parameters. The geometric parameters of each of the first set of blades and the second set of blades provide aeroelastic tailoring such that the second set of blades includes a greater degree of effective clipping during a second condition than at a first condition.

In accordance with another exemplary embodiment of the present disclosure, a method is provided. The method includes the steps of rotating a first set of blades relative to a second set of blades disposed downstream relative to the first set of blades and impacting a first wake generated by the first set of blades with the second set of blades such that a spectral content of wake excitation perceived, and an acoustic signal generated by the second set of blades is altered. Each of the first set of blades and the second set of blades include aeroelastic tailoring such that the second set of blades includes a greater degree of effective clipping during a first condition than at a second condition.

### DRAWINGS

These and other features, aspects, and advantages of the present disclosure will become better understood when the following detailed description is read with reference to the accompanying drawings in which like characters represent like parts throughout the drawings, wherein:

FIG. 1 is diagrammatical illustration of a turbomachine, and more particularly an open rotor aircraft gas turbine engine assembly with counter-rotatable blades, or propellers, having an exemplary blade arrangement in accordance with one or more embodiments shown or described herein;

FIG. 2 is a schematic longitudinal cross-sectional view of a portion of the engine illustrated in FIG. 1, including an exemplary embodiment of a first set of blades and a second set of blades, in accordance with one or more embodiments shown or described herein;

FIG. 3 is a schematic front view, looking aft, of a blades and a second set of blade in a turbomachine, during a first condition and a second condition, in accordance with one or more embodiments shown or described herein; and

FIG. 4 is a schematic side view of a two-dimensional cross-section of a first set of blades and a second set of blades in a turbomachine, in accordance with one or more embodiments shown or described herein;

FIG. 5 is a schematic front view, looking aft, of a forward blade in a turbomachine, in accordance with one or more embodiments shown or described herein;

FIG. 6 is a schematic side view of a two-dimensional cross-section of a first set of blades and a second set of blades in a turbomachine, in accordance with one or more embodiments shown or described herein;

FIG. 7 is a schematic front view, looking aft, of a forward blade in a turbomachine, during a first, no-load condition, in accordance with one or more embodiments shown or described herein;

FIG. 8 is a schematic front view, looking aft, of a forward blade in a turbomachine, during a second, load condition, in accordance with one or more embodiments shown or described herein;

FIG. 9 is a schematic front view, looking aft, of an aft blade in a turbomachine, during a first, no-load condition, in accordance with one or more embodiments shown or described herein; and

FIG. 10 is a schematic front view, looking aft, of an aft blade in a turbomachine, during a second, load condition, in accordance with one or more embodiments shown or described herein.

### DETAILED DESCRIPTION

Embodiments of the present disclosure relate to an apparatus, an assembly including the apparatus, and a method for reduction of wake interaction noise and improved efficiency in a turbo machine. As used herein, the apparatus, assembly and method are applicable to various types of turbomachinery applications such as, but not limited to compressors, turboshafts, turbojets, turbo fans, turbo propulsion engines, aircraft engines, gas turbines, steam turbines, wind turbines and water/hydro turbines. In addition, as used herein, singular forms such as “a”, “an”, and “the” include plural referents unless the context clearly dictates otherwise.

As discussed in detail below, embodiments of the disclosure include aeroelastically tailored propellers or blades; an apparatus including said aeroelastically tailored propellers or blades and a method for reduction of wake interaction noise and improved efficiency in apparatus such as turbomachines or the like. As used herein, the propellers, assembly and method are applicable to various types of applications having blade-wake interactions resulting in unsteady pressure. Further, the term ‘unsteady pressure’ as used herein refers to air unsteady pressures and acoustics as well as blade surface unsteady pressure that are also referred to as ‘aeromechanical loading’. The embodiments of the present disclosure are beneficial by allowing the designer the freedom to both reduce acoustic energy emitted by the system.

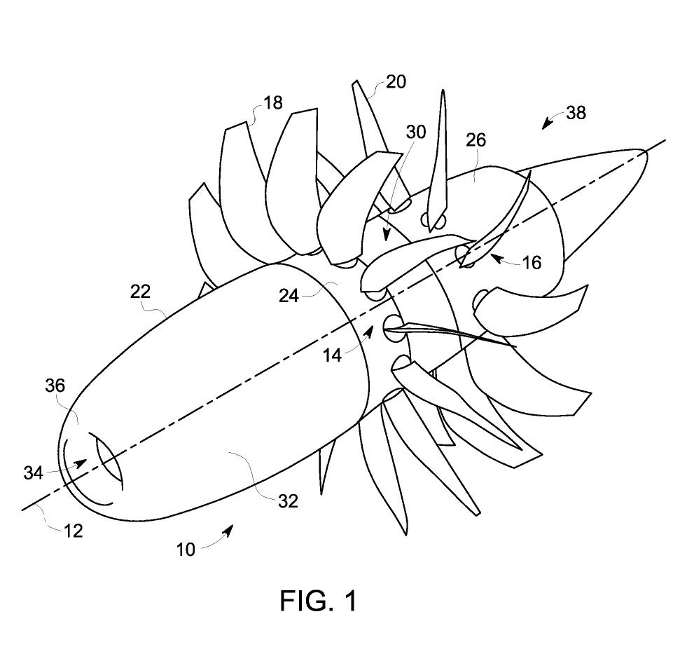

FIG. 1 illustrates an unducted fan (UDF) or open rotor aircraft gas turbine engine assembly 10 having a centerline axis 12 and axially spaced apart forward and aft annular rows 14, 16 of a first set of blades or propellers 18, also referred to herein as forward blades, and a second set of blades or propellers 20, also referred to herein as aft blades. In an embodiment, the first and second sets of blades or propellers 18 and 20 are configured in a counter-rotating arrangement. In an alternate embodiment, the second sets of blades or propellers 20 are configured stationary, so as to not rotate, relative to the first set of blades or propellers 18. Aeroelastic control of a height of R1 (as presently described) may be provided in either instance, irrespective of rotating or stationary configuration of the second set of blades or propellers 20. The engine assembly 10 includes an outer shell, or an outer casing 22 disposed co-axially about centerline axis 12. The outer casing 22 is conventionally referred to as a nacelle. The counter-rotatable forward and aft annular rows 14, 16 of first and second sets of blades or propellers 18, 20 are disposed radially outwardly of the outer casing, or nacelle, 22. The forward and aft annular rows 14, 16 are illustrated herein as having twelve (12) forward blades and ten (10) aft blades but other numbers of blades may be used. The nacelle 22 includes a forward fairing 24 which is coupled to and rotatable with the first set of blades 18 and an aft fairing 26 coupled to and rotatable with the second set of blades 20.

Each of the forward and aft annular rows 14, 16 comprise first and second sets of blades or propellers 18, 20, each including a plurality of circumferentially spaced airfoils, or fan blades, described presently. The forward and aft annular rows 14, 16 are counter-rotatable which provides a higher disk loading and propulsive efficiency. It should be appreciated that the aft annular row 16 of the second set of blades 20 serves to remove the swirl on the circumferential component of air imparted by the forward annular row 14 of the first set of blades 18. As described below, the first and second sets of blades 18, 20 in the forward and aft annular rows 14, 16 are aeroelastic tailored as described herein, to reduce fan noise emanating from the open rotor aircraft gas turbine engine assembly 10.

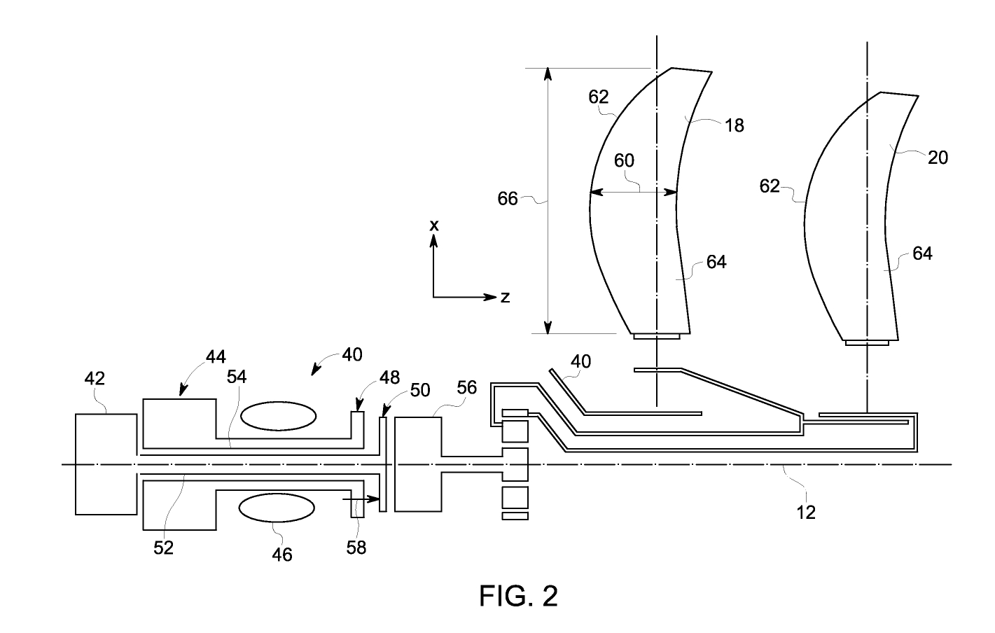

The nacelle 22 further includes a spacer fairing 30 disposed between the forward and aft fairings 24, 26 and a forward nacelle 32 disposed radially outwardly of and surrounding a gas generator 34, further described in FIG. 2. The forward nacelle 32 includes an inlet 36 that directs ambient air to the gas generator 34. The nacelle 22 may also provide the proper air flow characteristics to optimize the performance of the first and second sets of blades 18, 20.

The open rotor aircraft gas turbine engine assembly 10 illustrated in FIGS. 1 and 2 is a pusher type engine having the spaced apart counter-rotatable forward and aft annular rows 14, 16 of forward and aft blades 18, 20 located generally at an aft end 38 of the engine and aft of the gas generator 34 and the forward nacelle 22 surrounding the gas generator 34. The forward and aft annular rows 14, 16 of the forward and aft blades 18, 20 pusher type open rotor aircraft gas turbine engine assembly 10 are aft of an aft structural turbine frame 40 illustrated in FIG. 2. The aft structural turbine frame 40 is used to transfer thrust forces produced by the forward and aft blades 18, 20 to an aircraft (not shown) and hence the designation pusher. It should be understood that although described with reference to FIGS. 1 and 2 is a pusher type engine assembly, in an alternate embodiment, any type of open rotor aircraft gas turbine engine assembly is anticipated by this disclosure, such as a puller type engine assembly, or the like. Additionally, any power source architecture may be utilized to drive the fan (e.g., electric, hybrid turbo-electric, single core to multi-fan, etc.)

Referring to FIG. 2, in the illustrated pusher open rotor embodiment, the gas generator 34 is a gas turbine engine with low and high pressure compressor sections 42, 44, a combustor section 46, and high and low pressure turbine sections 48, 50 in a downstream axial flow relationship. The high and low pressure turbine sections 48, 50 drive the low and high pressure compressor sections 42, 44 through low and high pressure shafts 52, 54, respectively. Located aft and downstream of the low pressure turbine section 42 is a power turbine 56 which drives the forward and aft annular rows 14, 16 of forward and aft blades 18, 20. Air passing through the gas generator 34 is compressed and heated to form a high energy (high pressure/high temperature) gas stream 58 which then flows through the power turbine 56. As previously stated, in an alternate embodiment, any type of open rotor aircraft gas turbine engine assembly is anticipated by this disclosure, such as a puller type engine assembly, or the like.

As illustrated in FIGS. 1 and 2, the second set of blades 20 are disposed downstream of the first set of blades 18. In other embodiments, the first set of blades 18, and the second set of blades 20 may be located over the compressor sections 42, 44 or the turbine sections 48, 50. In the illustrated embodiment of FIG. 2, the first set of blades 18 is rotated relative to the second set of blades 20. During operation, the first set of blades 18 sheds a wake that is impacted by the second set of blades 20.

As previously indicated, a dominant source of open rotor noise and aeromechanical loading is the interaction of the wakes from upstream blades (e.g., pylon, upstream fan or wing) on the downstream bladerows (e.g., downstream stators, counter-rotatable fan or wing) moving relative to each other. As is well understood, the wake is defined as the region of reduced momentum behind an airfoil evidenced by the aerodynamic drag of the blade. The unsteady interaction noise sources contributing to community noise (particularly at takeoff) are often dominated by the upstream rotor, or blade tip vortices. To reduce noise, clipping of the aft blades or vanes, may be accomplished to extend radially only a distance sufficient to reduce/avoid the influence of these vortices. In addition, to provide high fan efficiency at cruise conditions, it is preferred that the aft blades, or vanes, extend sufficiently in a radial direction to fully deswirl the flow behind the upstream blades or vanes. To accomplish this contradiction, passive tailoring of the blade designs and radial extension with aeroelastic considerations is proposed and described presently. In an embodiment, passively tailoring provides that an aft positioned blade naturally appears more clipped at takeoff conditions to reduce noise while appearing less clipped at cruise conditions to improve efficiency. In yet another embodiment, such as in a wing-mounted installation, aeroelastically tailoring a blade height may not allow the wing to miss the vortex, but a higher level of dihedral (described presently), such as in a short R2, would allow for a quieter wing interaction due to phase benefits.

As previously indicated, this disclosure provides for modification of the blades, or propellers, to reduce tip vortex interaction noise while improving aerodynamic performance. The modifications include aeroelastically tailoring geometric parameters including the design of the blade sweep, dihedral (e.g., proplets) and twist distribution so that the blade deflections, and more particularly blade tip deflections, under mechanical and aerodynamic loading can be favorably controlled by blade speed ratio, also referred to as RPM ratio, via pitch setting. In an embodiment, each blade in the first set of blades 18 and the second set of blades 20 may define any suitable aerodynamic profile. Thus, in some embodiments, each of the blades may define an airfoil shaped cross-section that is aeroelastically tailored. In an embodiment, aeroelastic tailoring of the blades may entail bending or twisting the blades in generally a chordwise direction “z” and/or in a generally spanwise direction “x”. As illustrated in FIG. 2, the chordwise direction “z” generally corresponds to a direction parallel to a chord 60 defined between a leading edge 62 and the trailing edge 64 of each of the blades 18, 20. Additionally, the spanwise direction “x” generally corresponds to a direction parallel to a span 66 of the blade. In addition, aeroelastic tailoring as described presently, may include modifying any of blade sweep, blade dihedral, speed ratio between a takeoff condition and a cruise condition, speed ratio and/or torque ratio between the first set of blades 18 and second set of blades 20, blade pitch, camber, stagger, chord, blade thickness a trailing edge camber angle and blade stiffness (such as including, but not limited to modifying material composition and design (e.g., composite ply lay-up design, functionally graded metals or materials in an additive manufacturing process, or multi-material design such as metal spar+composite skin, etc.)

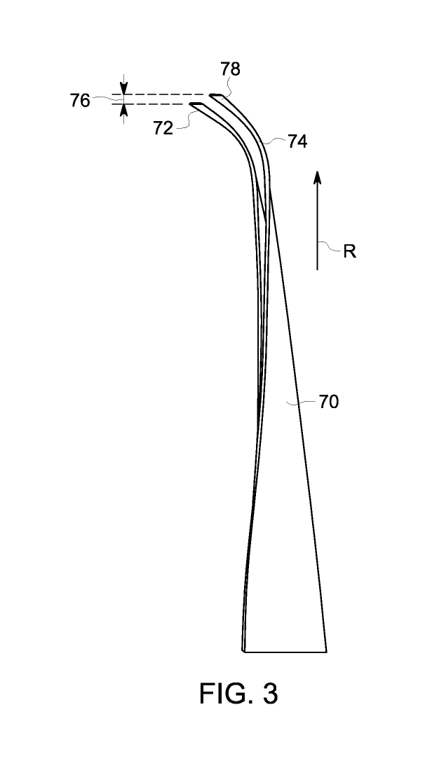

Referring now to FIG. 3, illustrated in a forward view looking aft directionally, is a single blade 70 of the first set of blades 18, as illustrated in FIGS. 1 and 2. Blade 70 is depicted under both a low load, first condition 72, such as during cruise conditions, and deformed aeroelastically, under a higher loading, or second condition 74, such as during takeoff conditions as a result of aerodynamic and mechanical forces. Generally stated, aerodynamic load distribution and magnitude are different between cruise and takeoff conditions. Mechanical forces are the primary force for radial deflection of the blades 18. More specifically, changing the speed ratio directly scales the centripetal loading at a tip 78, thereby affecting how the blade height deforms aeroelastically. As previously described, blade 70 may include aeroelastic tailoring, such as deflecting the blade 70 in generally the chordwise direction “z” and/or spanwise direction “x”. As illustrated, during the high loading condition 74, the blade 70 extends in a radially direction, as indicated at “R”, and amount 76 so that a tip vortex generated by the blade 70 in the first set of blades 18 and positioned in the forward annular row 14, as illustrated in FIGS. 1 and 2, misses a blade tip of a blade (described presently) in the second set of blades 20 positioned in the aft annular row 16, as illustrated in FIGS. 1 and 2.

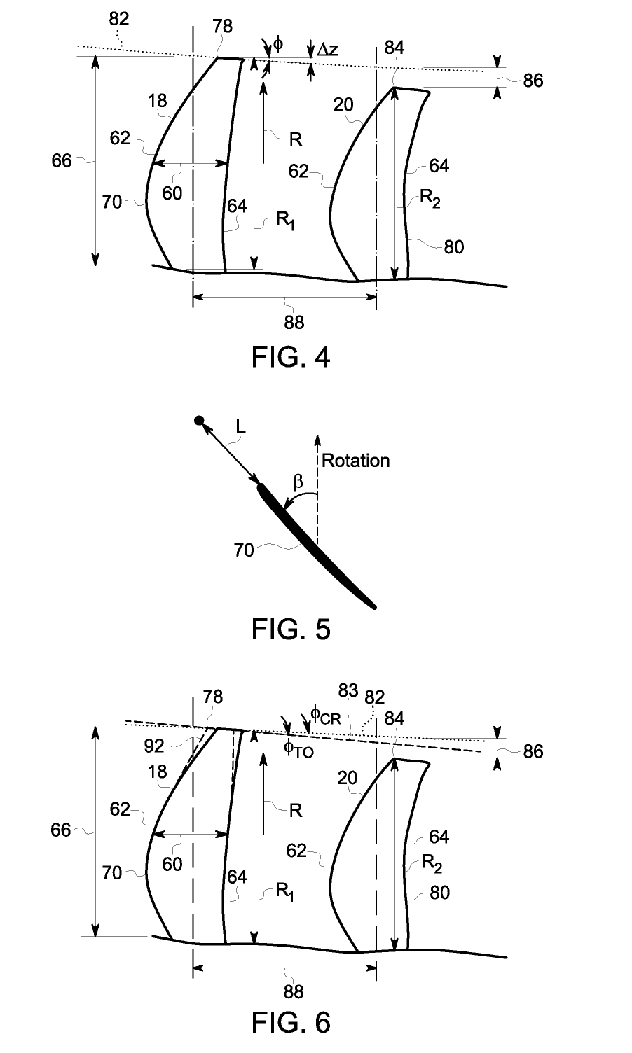

FIG. 4 illustrates the single blade 70 of the first set of blades 18 positioned in the forward annular row 14, as previously described and a single blade 80 of the second set of blades 20 positioned in the aft annular row 16, as previously described. Blades 70 and 80 are illustrated during a high loading condition 74, such as during takeoff as previously detailed. As illustrated, the single blade 70 in the forward position is aeroelastically tailored to provide deformation, resulting in a radius R₁ of the single blade 70 that is greater than a radius R₂ of the single blade 80, positioned downstream and aft of blade 70, relative to R₁ at cruise condition. It should be noted that an optimal cruise design typically provides R1>R2 due to the contraction of the flow stream. For lower flight speeds and higher fan loading, such as during takeoff conditions of operation, the flow contraction is steeper so a preferred design would include greater R2 clipping relative to a typical cruise streamtube. Such clipping if implemented in the aft blades 80 by employing a shorter blade would decrease performance at cruise and hence it is desirable to minimize clipping for performance reasons. Therefore, as illustrated, the radial extension and other geometric parameters of each of the forward single blades 70 and the aft single blades 80, including blade sweep and twist, are aeroelastically tailored to provide a tip streamline, as indicated in dashed line 82, of the forward single blade 70 to miss a tip 84 of the aft single blade 80 by a greater distance than afforded by passively clipping. This additional effective clipping provided by aeroelastic tailoring reduces noise at a highly loaded, takeoff condition while still maintaining performance at a lightly loaded, cruise condition. In an embodiment, blades 70 and/or blade 80 may further include aeroelastic tailoring of additional geometric parameters, such as dihedral (e.g., proplets) described presently.

As illustrated in FIG. 4, the aft positioned single blade 80 is effectively clipped, as indicated at 86, in light of the deformation, and more particularly radial extension, of the forward single blade 70 during the high loading condition 74. During a more lightly loaded condition 72, the forward single blade 70 does not include as much radial extension, in effect providing less “clipping” as it relates to the aft single blade 80 thereby improving efficiency. In addition, spacing, 88 between the forward single blade 70 and the aft single blade 80 may be tailored, as is described presently.

In an embodiment, a closed pitch angle setting for forward blades 70 would translate a tip 78 axially forward, also effectively reducing clipping, the amount of which depends on the amount of sweep and twist in the blade design. Increased forward blade rotation speeds to aeroelastically deform the blade tip radially outward must account for this effect to attain the desired change to effective clipping. Conversely, reducing the rotation speed of the aft blades 80 to aeroelastically shorten the radial extent would translate their tip 84 axially downstream, also effectively reducing clipping. Consideration of blade pitch setting between a highly loaded condition 74, such as takeoff (closed) and a less loaded condition 72, such as cruise (open), may also have an effect. A flow stream tube contracts radially inward, with a steeper contraction angle at highly loaded fan settings and slower flight velocities as depicted by 83 relative to 82. When the blade 70 closes and the blade tip 78 is swept aft of the pitch axis, the tip 78 is positioned axially forward, compared to more open pitch settings such as that illustrated in FIG. 4. For forward swept blades, the opposite effect occurs. For the forward blade 70, this axial shift results in an effective radial displacement of the tip vortex streamline 82 given by dᵣ=−d_{z} tan Φ. The axial shift is given by d_{z}=−L(sin β_{TO}−sin β_{CR}) where L is the leading edge 62 offset to the pitch axis (affected by sweep), and β is relative to the propeller rotation direction (combination of pitch+pressure-side dihedral/L), as best illustrated in FIG. 5. Where β_{TO}=takeoff fan pitch setting, β_{CR}=cruise fan pitch setting, dᵣ=radial offset at takeoff relative to cruise, and d_{z}=axial offset at takeoff relative to cruise. Presuming a cruise design that matches the forward blade 70 and aft blade 80 tip streamlines, higher aft blade 80 clipping at takeoff would dictate the forward blade 70 should minimize its axial movement relative to cruise, and for U_{TO}/U_{CR}>1, where U_{TO}=fan tip speed at takeoff and U_{CR}=fan tip speed at cruise. In addition, a suction or pressure side dihedral (described presently) maybe employed provided the blade stiffness is low enough to effect sufficient radial straightening. For aft blade 80, the axial forward shift should be maximized to increase effective clipping (assuming clipping benefit outweighs the slightly stronger wakes); hence for U_{TO}/U_{CR}<1, a suction-side dihedral may be used if the contraction angle is large enough to overcome the radial stand-up (controlled by bending stiffness).

In addition to the previous described aeroelastic tailoring of the blades 70, 80, additional aeroelastic tailoring may be provided the first and second sets of blades 18, 20 such that the aft blades 80 naturally appear more clipped at takeoff while appearing less clipped (possibly optimal) at cruise. Referring now to FIGS. 6-10, illustrated in a side schematic view, blades 70, 80 may include high dihedral deflections which depend strongly on speed ratio and aero loading.

Dihedral may be used to improve noise and performance by controlling the relative distance between the aft blade tip 80 and the forward blade tip vortex streamline 82, by optimizing this distance to be minimal at cruise, yet maximum at takeoff. When optimized, the aft blade tip 84 is substantially below the vortex at takeoff yet aligned with the vortex at cruise. When a blade has substantial dihedral, centripetal loading will deflect the blade to “stand up”, or extend radially, as indicated by “R”, as the speed is increased. Depending on the speed ratio ratio between takeoff and cruise conditions (U_{TO}/U_{CR}), which for other reasons is typically desired to be >1, the forward blade 70 should maximize dihedral to be tallest at takeoff, or a highly loaded condition 74 making the aft blade 80 appear shorter, and in effect shifting the tip streamline 83 outboard, as best illustrated in FIG. 6. At a lower cruise tip speed, at a less loaded condition 72, the forward blade 70 will shorten to line up tip streamline 82 with the aft blade tip to maximize efficiency. Designing blade dihedral in this fashion potentially enables aft blade clipping for takeoff noise without penalizing cruise performance.

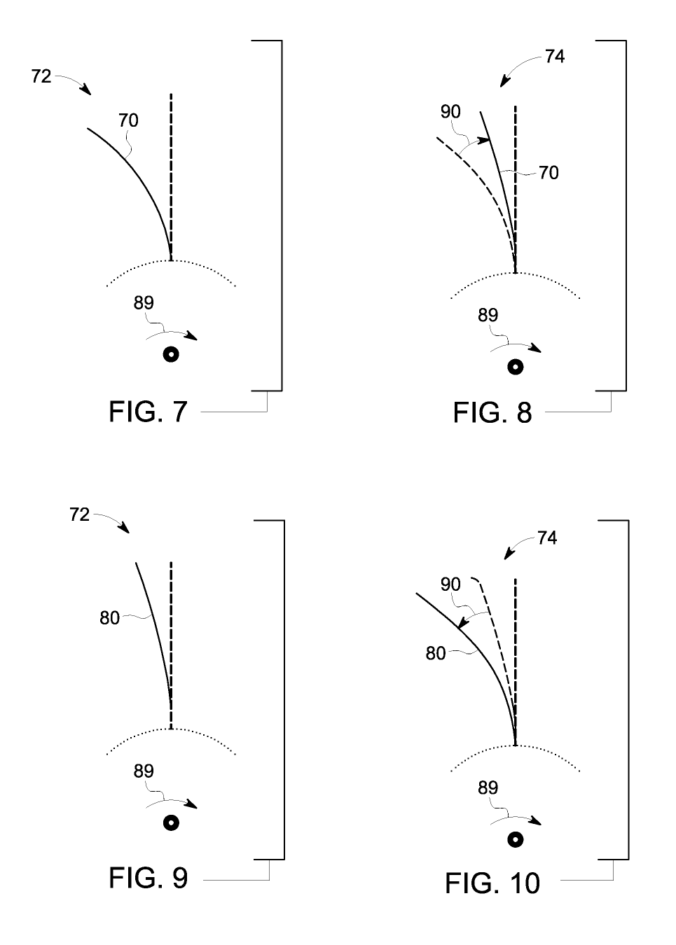

In the illustrated embodiment, a suction-side dihedral is aeroacoustically preferred (relative to pressure side dihedral) for each blade 70, 80, in the first and second sets of blades 18, 20, respectively. To achieve such aeroelastic tailoring, in an embodiment, a suction-side dihedral stacking is applied to each blade 70, 80, in the first and second sets of blades 18, 20. As best illustrated in FIGS. 7 and 8, each blade 70 in the first set of blades 18 is designed for a low cruise speed, as best illustrated in FIG. 7, and a high takeoff speed, as best illustrated in FIG. 8. Rotational movement is indicated by directional arrow 89. This will effectively radially lengthen each blade 70 at takeoff, as indicated by directional arrow 90, such that the tip vortex of each blade 70 is positioned further outboard. It should be understood that an actual arc length will not change, but a radial height will increase. As best illustrated in FIGS. 9 and 10, each blade 80, in the second set of blades 20 is designed in the opposite sense. More particularly, each blade 80 is designed for high speed cruise as best illustrated in FIG. 9 so as to lengthen the blade 80 to achieve better aero efficiency, and low speed at takeoff, as best illustrated in FIG. 10, so as to shorten the blade 80 and achieve more effective blade clipping at takeoff. FIG. 6 further illustrates the suction side dihedral edge projection, generally referenced as dotted line 92. It will however be recognized by one skilled in the art that other noise considerations may require a different embodiment of aeroelastic tailoring. For instance, if the intent is to reduce rotor self-noise at cruise conditions for cabin noise reduction, aeroelastic tailoring may be applied in such a way as to re-orient the propeller tip acoustic dipole away from the cabin by modifying tip stagger, sweep and dihedral. In another instance, aeroelastic tailoring may be applied to minimize propeller noise increase at a high aircraft or wing angle of attack operation by modifying the distribution of tip stagger, sweep, and dihedral to reduce aerodynamic loading at the tip of the forward or aft set of blades. Finally, aeroelastic tailoring may also be applied to reduce aeromechanical loading caused by wakes or angle of attack changes by modifying the distribution of tip stagger, sweep, and dihedral to reduce aerodynamic loading. By carefully tailoring the blade stiffness and geometric properties, flutter stability due to twist-bend coupling may also be improved.

The various embodiments discussed herein for reduction of unsteady pressure in turbomachinery thus provide a convenient and efficient means to reduce aerodynamic noise and/or aeromechanical loading caused by interaction of wakes between sets of blades moving relative to each other. The technique provides a design for low cruise and high takeoff tip speeds whereby a first wake generated by a first set of blades impacts a second set of blades such that a spectral content of wake excitation perceived, and an acoustic signal generated by the second set of blades, is altered. In addition, performance is enhanced by reclaiming a portion of a downstream blade clipping performance penalty. For high fan efficiency at cruise, the aft blades are preferably of a sufficient length to fully deswirl the flow behind the upstream blades. Accordingly, provided herein is a means to achieve passive tailoring of the forward and aft blade designs with aeroelastic considerations such that the aft blade naturally appears more clipped at takeoff while appearing less clipped at cruise. The aeroelastic tailoring is accomplished such that reducing effective blade stiffness does not pose risk to the aeromechanical capability of the fan blades. The aeroelastic effects may be controlled by the degree of blade stiffness, sweep, dihedral, speed ratio between takeoff and cruise, and corresponding pitch settings. Reducing open rotor noise by this means provides further noise reduction and/or reduction in efficiency penalties associated with other noise designs and technologies that require performance compromises.

The concepts described above may also be employed to further reduce spacing between the forward and aft set of blades, thereby improving engine weight and fuel burn. For example, in an embodiment axially forward movement of a forward blade, such as forward blade 70, from a cruise pitch angle setting to a takeoff setting may be enhanced by a suction side dihedral. While this reduces effective clipping of an associated aft blade, such as aft blade 80, the increased curvature or arc-length of the wake shed from the forward blade (relative to a design where aeroelastic tailoring and blade stacking is not applied) is higher. Furthermore, the wakes have a longer axial gap to mix before impinging on the aft blade.

In the illustrated embodiments, the geometric parameters may be varied depending on the application. Furthermore, the skilled artisan will recognize the interchangeability of various features from different embodiments. For example, the first set of blades or second set of blades may include further geometric variations of at least one of a camber, a stagger, a chord, a blade thickness, and a trailing edge camber angle with respect to another. Similarly, the various features described, as well as other known equivalents for each feature, can be mixed and matched by one of ordinary skill in this art to construct additional systems and techniques in accordance with principles of this disclosure.

It is to be understood that not necessarily all such objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein

While the technology has been described in detail in connection with only a limited number of embodiments, it should be readily understood that the specification is not limited to such disclosed embodiments. Rather, the technology can be modified to incorporate any number of variations, alterations, substitutions or equivalent arrangements not heretofore described, but which are commensurate with the spirit and scope of the claims. It is, therefore, to be understood that the appended claims are intended to cover all such modifications and changes as fall within the true spirit of the disclosure. Additionally, while various embodiments of the technology have been described, it is to be understood that aspects of the specification may include only some of the described embodiments. Accordingly, the specification is not to be seen as limited by the foregoing description, but is only limited by the scope of the appended claims.

What is claimed is:

1. An apparatus, comprising:
one or more upstream blades each comprising one or more geometric parameters; and
one or more downstream blades disposed downstream relative to the one or more upstream blades and each comprising one or more geometric parameters,
wherein the geometric parameters of each of the one or more upstream blades and the one or more downstream blades provide aeroelastic tailoring such that the one or more downstream blades includes a greater degree of effective clipping during a second condition than at a first condition.

2. The assembly of claim 1, wherein the first condition is a cruise condition of operation, the second condition is a takeoff condition of operation and wherein the first condition has a lesser load condition than the second condition.

3. The apparatus of claim 1, wherein the one or more downstream blades are disposed offset along a circumferential direction and an axial direction relative to the one or more upstream blades.

4. The apparatus of claim 1, wherein the one or more upstream blades comprise a plurality of rotatable blades.

5. The apparatus of claim 4, wherein the one or more downstream blades comprise a plurality of rotatable blades and wherein the one or more upstream blades are counter rotatable relative to the one or more downstream blades.

6. The apparatus of claim 4, wherein the one or more downstream blades comprise a plurality of stationary blades.

7. The apparatus of claim 1, wherein the one or more upstream blades comprise one of a pylon, an upstream fan or a wing of an aircraft.

8. The apparatus of claim 1, wherein the one or more geometric parameters comprise at least one of a blade stiffness, a blade sweep, a blade dihedral, a speed ratio between the first condition and the second condition and a spacing between each of the one or more upstream blades relative to each of the one or more downstream blades.

9. The apparatus of claim 1, wherein the apparatus comprises a turbomachine.

10. An open rotor aircraft gas turbine engine assembly comprising:
an outer casing;
a gas generator housed within the outer casing, the gas generator comprising:
a compressor section;
a combustor section; and
a turbine section, wherein the compressor section, the combustor section and the turbine section are configured in a downstream axial flow relationship,
a forward annular row of a first set of blades disposed radially outwardly of the outer casing, each blade of the first set of blades comprising one or more geometric parameters;
an aft annular row of a second set of blades disposed radially outwardly of the outer casing, each blade of the second set of blades comprising one or more geometric parameters;
wherein the geometric parameters of each of the first set of blades and the second set of blades provide aeroelastic tailoring such that the second set of blades includes a greater degree of effective clipping during a second condition than at a first condition.

11. The assembly of claim 10, wherein the first condition is a cruise condition of operation, the second condition is a takeoff condition of operation and wherein the first condition has a lesser load condition than the second condition.

12. The assembly of claim 10, wherein the second set of blades are disposed offset along a circumferential direction and an axial direction relative to the first set of blades.

13. The assembly of claim 10, wherein the first set of blades comprises a plurality of rotatable blades.

14. The assembly of claim 13, wherein the second set of blades comprises a plurality of rotatable blades and wherein the first set of blades are counter rotatable relative to the second set of blades.

15. The assembly of claim 10, wherein the one or more geometric parameters comprise at least one of a blade stiffness, a blade sweep, a blade dihedral, a speed ratio between the first condition and the second condition and a spacing between each of the one or more upstream blades relative to each of the one or more downstream blades.

16. The assembly of claim 15, wherein the one or more geometric parameters may further comprise at least one of a camber, a stagger, a chord, a blade thickness and a trailing edge camber angle.

17. A method, comprising:
rotating a first set of blades relative to a second set of blades disposed downstream relative to the first set of blades, wherein each of the first set of blades and the second set of blades include aeroelastic tailoring such that the second set of blades includes a greater degree of effective clipping during a first condition than at a second condition.
impacting a first wake generated by the first set of blades with the second set of blades such that a spectral content of wake excitation perceived, and an acoustic signal generated by the second set of blades is altered.

18. The method of claim 17, wherein the first set of blades comprises one or more geometric parameters and the second set of blades comprises one or more geometric parameters.

19. The method of claim 18, wherein the one or more geometric parameters comprise at least one of a blade stiffness, a blade sweep, a blade dihedral, a speed ratio between the first condition and the second condition and a blade pitch.

20. The method of claim 19, wherein the one or more geometric parameters may further comprise at least one of a camber, a stagger, a chord, a blade thickness and a trailing edge camber angle.
